(19) United States
(12) Patent Application Publication
(10) Pub. No.: US 2024/0135295 A1
(43) Pub. Date: Apr. 25, 2024

(54) EVALUATION DEVICE, EVALUATION SYSTEM, AND EVALUATION PROGRAM

(71) Applicant: VANISH STANDARD CO., LTD., Tokyo (JP)

(72) Inventor: Yasuaki ONOZATO, Tokyo (JP)

(21) Appl. No.: 18/559,588

(22) PCT Filed: May 31, 2021
(86) PCT No.: PCT/JP2021/020790

§ 371 Date: Nov. 8, 2023

(51) Int. Cl. G06Q 10/0639; G06Q 30/0251

(52) U.S. Cl. CPC G06Q 10/0639; G06Q 30/0268

(57) ABSTRACT

An evaluation device includes a salesperson evaluation unit 22 evaluating each salesperson from a status relevant to the sales of a product subjected to a sales promotion by each of the salespersons, on the basis of an association between sales status information of the product on an EC site and salesperson information, and a store evaluation unit 23 evaluating a store from the overall status relevant to the sales of the product subjected to the sales promotion by each of the salespersons, on the basis of an association between the sales status information, the salesperson information, and store information indicating the store to which the salesperson belongs, in which when the salesperson performs the sales promotion on the EC site, by not only evaluating the salesperson oneself, on the basis of the status relevant to the sales of the product, but also evaluating the store to which the salesperson belongs, on the basis of the overall status relevant to the sales of the product subjected to the sales promotion by each of the salespersons belonging to the store, it is possible to inhibit a store manager from suppressing the implementation of a digital customer service by the salesperson, and improve a sales performance of the product by increasing the motivation of the salesperson.

### TECHNICAL FIELD

The present invention relates to an evaluation device, an evaluation system, and an evaluation program, and is particularly preferably used in a system performing evaluation on the basis of a status relevant to the sale of a product in a company operating a physical store and an EC site.

### BACKGROUND ART

In the related art, a system is known in which a motivation for sales is improved by applying an incentive such as a point or a bonus to a salesperson selling a product, on the basis of a sales performance or the like (for example, refer to PTL 1).

In the system described in PTL 1, the incentive is applied to the salesperson who causes a user to purchase the product by using an EC site. For example, a salesperson code associated with a product code of a recommended product (a product selected by a person in charge of product management) is read out from an order information storage unit, and the incentive (an amount at a predetermined ratio of the order volume of the recommended product, a predetermined amount according to the number of recommended products ordered, or the like) is applied to a salesperson corresponding to the salesperson code.

As described in PTL 1, an object of applying the incentive according to the sales performance to the salesperson is to motivate the salesperson, improve each sales performance, and eventually improve the sales of the company to which the salesperson belongs. However, in a company selling products on both of an EC site and a physical store, in a case where the salesperson is overzealous in a sales promotion on the EC site (hereinafter, may be referred to as a digital customer service) in order to gain the incentive, there is a possibility that an adverse effect occurs in which a sales task (hereinafter, may be referred to as a real customer service) at the physical store may be neglected, and the sales at the physical store may not increase as intended.

In general, a budget (a sales target) is set for each predetermined period in each of the stores operated by the company, and it is evaluated whether the budget is achieved. The evaluation of the store is usually reflected on the evaluation of a store manager who is a responsible person of the store. Accordingly, in a case where each of the salespersons belonging to the store contributes to the sales improvement of the company by selling more products through the digital customer service, but the real customer service is neglected, and the sales at the physical store does not increase, and thus, the budget at the store is not achieved, there is a possibility that the store manager of the store receives a negative evaluation. Accordingly, it is considered that the store manager may suppress the implementation of the digital customer service by the salesperson, which may demotivate the salesperson.

Note that, a system in which sales achieved by means of an online supermarket sales method is aggregated as sales at a physical store is disclosed in PTL 2. The online supermarket sales method is a sales method in which a customer to be a member is capable of ordering a product at a retail shop using network communication such as the internet, by manipulating a customer terminal such as a personal computer at home. In the retail shop, a sales assistant moves around a saleroom and prepares ordered products, in accordance with the order from the customer, and a person in charge of shipping delivers the ordered products to the customer's home.

The system described in PTL 2 premises that the product that is transacted by the online supermarket sales method is a product that is actually sold at the physical store, and collectively aggregates the sales of commercial transaction by means of the online supermarket sales method as the sales of the physical store as well. However, PTL 2 only discloses that the sales of the product sold by using the network communication is recognized as the sales of the physical store, but does not mention about the evaluation or the application of the incentive.
PTL 1: JP2014-182760A
PTL 2: JP2011-186686A

### SUMMARY OF INVENTION

### Technical Problem

The invention has been made in order to solve the problems as described above, and an object thereof is to inhibit a negative factor that cause demotivation for a salesperson to a digital customer service, and improve a sales performance of a product.

### Solution to Problem

In order to attain the object described above, in the invention, each salesperson is evaluated from a status relevant to the sales of a product subjected to a sales promotion by each of the salespersons, on the basis of association between sales status information indicating the status relevant to the sales of the product on an EC site of a company operating one or more physical stores and EC sites and salesperson information indicating the salesperson who has performed the sales promotion of the product, and evaluates a store from the overall status relevant to the sales of the product subjected to the sales promotion by each of the salespersons belonging to the store, on the basis of an association between the sales status information, the salesperson information, and store information indicating the store to which the salesperson belongs.

### Advantageous Effects of Invention

According to the invention configured as described above, in a case where the salesperson of the company operating one or more physical stores and EC sites performs the sales promotion (a digital customer service) in order to sell the product on the EC site, not only the salesperson oneself is evaluated on the basis of the status relevant to the sales of the product, but also the store to which the salesperson belongs is evaluated on the basis of the overall status relevant to the sales of the product subjected to the sales promotion by each of the salespersons belonging to the store. As described above, in a case where the salesperson sells more products on the EC site through the digital customer service, not only the salesperson but also the store is evaluated, and thus, a store manager is inhibited from suppressing the implementation of the digital customer service by the salesperson, that is, the negative factor that cause the demotivation for the salesperson to the sales of the product on the EC site is inhibited. Accordingly, it is possible to improve the sales performance of the product by effectively using the motivation of the salesperson to sell more products.

### BRIEF DESCRIPTION OF DRAWINGS

FIG. 1 is a diagram illustrating an overall configuration example of an evaluation system according to this embodiment.

FIG. 2 is a block diagram illustrating a functional configuration example of a salesperson terminal according to this embodiment.

FIG. 3 is a block diagram illustrating a functional configuration example of a server device according to this embodiment.

FIG. 4 is a diagram illustrating an example of a coordination posting page.

FIG. 5 is a diagram illustrating an example of a product detailed page.

FIG. 6 is a diagram illustrating an example of a posting list page.

FIG. 7 is a diagram illustrating an example of product master information stored in a product master storage unit.

FIG. 8 is a diagram illustrating an example of salesperson master information stored in a salesperson master storage unit.

FIG. 9 is a diagram illustrating an example of posting-related information (sales promotion management information) stored in a sales status storage unit.

FIG. 10 is a diagram illustrating an example of sales status information (sales performance information) stored in the sales status storage unit.

FIG. 11 is a schematic view for illustrating an example of processing details of a salesperson evaluation unit and a store evaluation unit.

### DESCRIPTION OF EMBODIMENTS

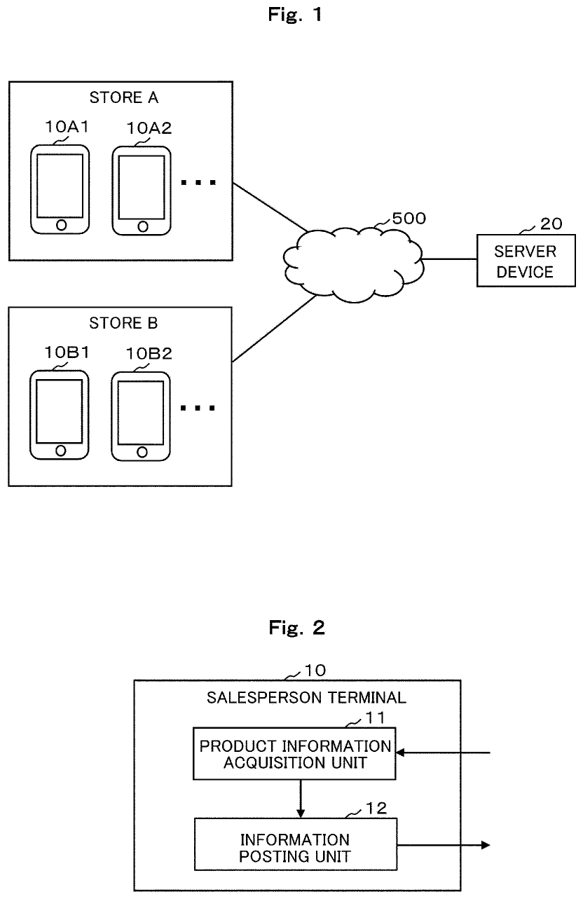

Hereinafter, one embodiment of the invention will be described on the basis of the drawings. FIG. 1 is a diagram illustrating an overall configuration example of an evaluation system according to this embodiment. As illustrated in FIG. 1, the evaluation system of this embodiment includes salesperson terminals 10A1, 10A2, 10B1, 10B2, . . . used by a plurality of salespersons belonging to stores A and B, and a server device 20. The server device 20 is connected from each of the salesperson terminals 10A1, 10A2, 10B1, 10B2, . . . through a communication network 500 such as the internet and a mobile telephone network.

The salesperson terminals 10A1, 10A2, . . . are terminals used by a plurality of salespersons A1, A2, . . . belonging to the store A. In addition, the salesperson terminals 10B1, 10B2, . . . are terminals used by a plurality of salespersons B1, B2, . . . belonging to the store B. Here, the stores A and B are physical stores existing at different spots. In the following description, when each of the salesperson terminals 10A1, 10A2, . . . , 10B1, 10B2, . . . is not particularly distinguished, the salesperson terminals will be simply referred to as a salesperson terminal 10. Note that, here, two stores A and B are illustrated, but the number of stores is not limited thereto. There may be one physical store, or there may be three or more physical stores.

The salesperson terminal 10 is a terminal used by the salesperson selling a product that is a sales target of a company (hereinafter, referred to as a sales target product), and for example, is a smart phone, a tablet terminal, a personal computer, and the like. In this embodiment, the company is a company operating one or more physical stores and EC sites. The sales target product is a product sold through the EC site. The product sold through the EC site may be identical to or different from a product sold at the physical store. Hereinafter, it will be described that a fashion-related product is sold, as an example of the product.

In the salesperson terminal 10, a support application (hereinafter, referred to as a sales support app) that enables the salesperson to implement a sales promotion (a digital customer service) regarding the sales target product is installed. The salesperson implements the sales promotion of the sales target product by using the function of the sales support app. Examples of an implementation function of the sales promotion provided by the sales support app include a fashion coordination posting function. This is a function (the details thereof will be described below) of associating product information with a coordination picture captured by the salesperson to be posted to the EC site.

The server device 20 performs processing relevant to the sales of the sales target product on the EC site and performs processing relevant to the evaluation of the salesperson selling the sales target product and the store to which the salesperson belongs, and has the functions of a sales management device and an evaluation device. Here, the function of the sales management device and the function of the evaluation device are provided in one server device 20, but such functions may be divided into two or more servers.

The processing relevant to the sales, which is the function of the sales management device, is each processing piece required to sell the sales target product through the EC site, and includes processing such as the posting of the product information, the registration of a product designated by a consumer to a shopping cart, and the payment of the product registered to the shopping cart. The posting of the product information to the EC site includes processing of posting the sales target product that is posted by the salesperson using a coordination posting function of the sales support app.

The processing relevant to the evaluation, which is the function of the evaluation device includes processing of evaluating the salesperson who has performed the sales promotion, on the basis of the sales status of the sales target product, and processing of evaluating the store to which the salesperson belongs. As a premise for performing the evaluation, the server device 20 executes each processing piece required to aggregate the sales status of the sales target product sold through the EC site.

FIG. 2 is a block diagram illustrating a functional configuration example of the salesperson terminal 10 according to this embodiment. As illustrated in FIG. 2, the salesperson terminal 10 of this embodiment includes a product information acquisition unit 11 and an information posting unit 12, as a functional configuration. Such functional blocks 11 and 12 actually include CPU, RAM, ROM, or the like of a computer, and are attained by operating a program of the sales support app stored in a storage medium such as RAM, ROM, a hard disk, or a semiconductor memory.

The product information acquisition unit 11 acquires the product information indicating a product included in target coordination to be posted by the salesperson (a product subjected to the sales promotion) from product master information managed as information of the sales target product in the server device 20. Here, the product information to be acquired may be information that is capable of specifying the product. For example, a product code uniquely allocated to the product can be used.

The information posting unit 12 posts information relevant to the sales promotion of the sales target product (hereinafter, referred to as sales promotion information) to the EC site of the company. The sales promotion information, for example, is related information such as the coordination picture captured by the salesperson or a comment created by the salesperson in association with the coordination picture. Here, the information posting unit 12 posts the sales promotion information to the EC site by associating the product information indicating the product subjected to the sales promotion (the product information acquired by the product information acquisition unit 11), salesperson information indicating the salesperson performing the sales promotion, and store information indicating the store to which the salesperson performing the sales promotion belongs with the sales promotion information.

In the following description, posting the sales promotion information (coordination information described below is synonymous with this term) indicates that the product information, the salesperson information, and the store information, which are associated with the sales promotion information, are also transmitted to the server device 20 together with the sales promotion information. In addition, in the following description, the sales promotion information (the coordination information), the product information, the salesperson information, and the store information, which are transmitted to the server device 20 from the salesperson terminal 10, will be collectively referred to as posting-related information.

The salesperson information may be information that is capable of specifying the salesperson. For example, a salesperson code uniquely allocated to the salesperson can be used. The store information may be information that is capable of specifying the store. For example, a store code uniquely allocated to the store can be used. For example, the salesperson code and the store code are registered in advance in the sales support app used by the salesperson, and the salesperson code and the store code, which are registered in advance, and the product code acquired by the product information acquisition unit 11 are associated with the sales promotion information created by the salesperson.

The EC site to which the sales promotion information is posted is a website that is operated by the company to sell the sales target product. The EC site includes a coordination posting page displaying the coordination information (the sales promotion information including the related information such as the coordination picture or the comment) posted from the salesperson, in addition to a product catalog page displaying a plurality of products as a list, a product detailed page displaying detailed information of each of the products, and the like.

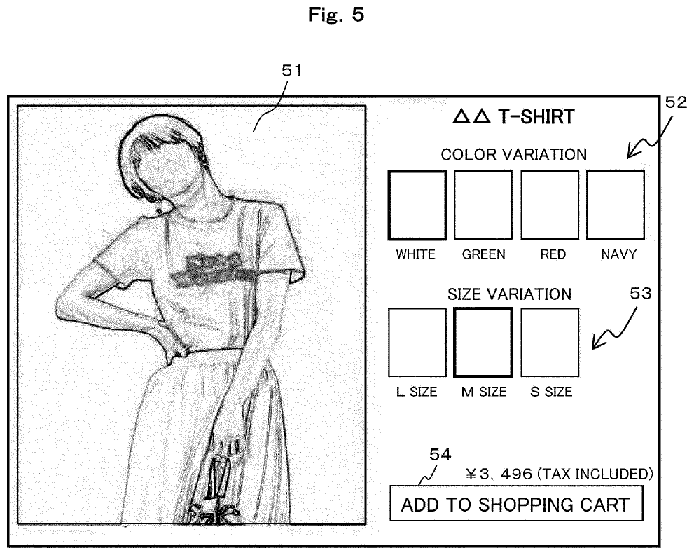

FIG. 4 is a diagram illustrating an example of the coordination posting page on which the coordination information posted from a certain salesperson is displayed. As illustrated in FIG. 4, a coordination picture 41, a name 42 of the store to which the salesperson belongs, salesperson related information 43, a comment 44 of the salesperson relevant to the coordination, and product-related information 45 of each of the products included in the coordination picture 41 are posted to the coordination posting page. The salesperson related information 43, for example, includes information such as the picture, the name, or the body height of the salesperson. The product-related information 45, for example, includes information such as the picture, the product name, or the price of the product. The coordination posting page is generated in the server device 20, on the basis of the posting-related information transmitted to the server device 20 from the salesperson terminal 10, and the product master information and the salesperson master information retained by the server device 20.

In the example of FIG. 4, the coordination picture 41 in which a product X of gathered pants and a product Y of a T-shirt are combined is posted, and information pieces relevant to two products X and Y are each posted to the product-related information 45. Here, for example, in the case of clicking the picture of the product X or the product Y, a transition to the product detailed page of the product X or the product Y is performed.

FIG. 5 is a diagram illustrating an example of the product detailed page. As illustrated in FIG. 5, the product detailed page includes a product picture 51, a color selection field 52, a size selection field 53, and a shopping cart button 54. The consumer is capable of registering the designated product to the shopping cart by selecting a desired color and a desired size and manipulating the shopping cart button 54.

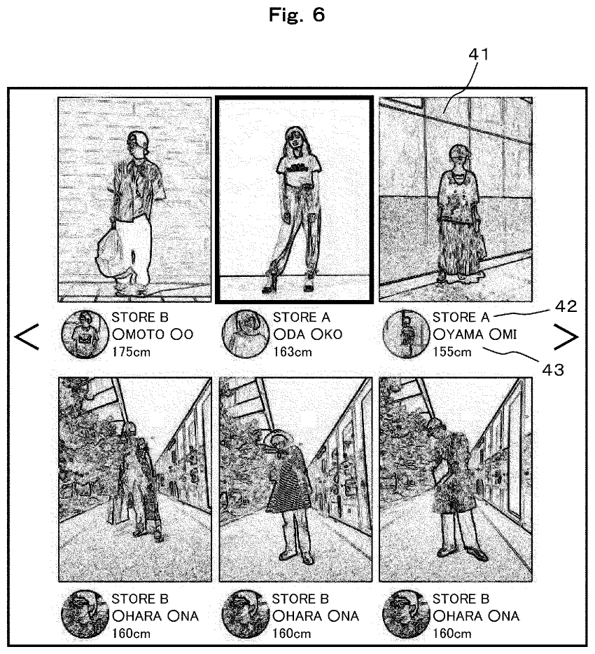

FIG. 6 is a diagram illustrating an example of the posting list page. A plurality of salespersons each perform one or more coordination postings, and thus, a plurality of coordination information pieces are accumulated in the server device 20. The posting list page illustrated in FIG. 6 is a page for displaying the outline of a plurality of coordination postings as a list. As illustrated in FIG. 6, for each of the coordination postings, the coordination picture 41, the name 42 of the store to which the salesperson belongs, and the salesperson related information 43 are posted to the posting list page. In the case of clicking any of the coordination pictures 41, a transition to the coordination posting page illustrated in FIG. 4 is performed.

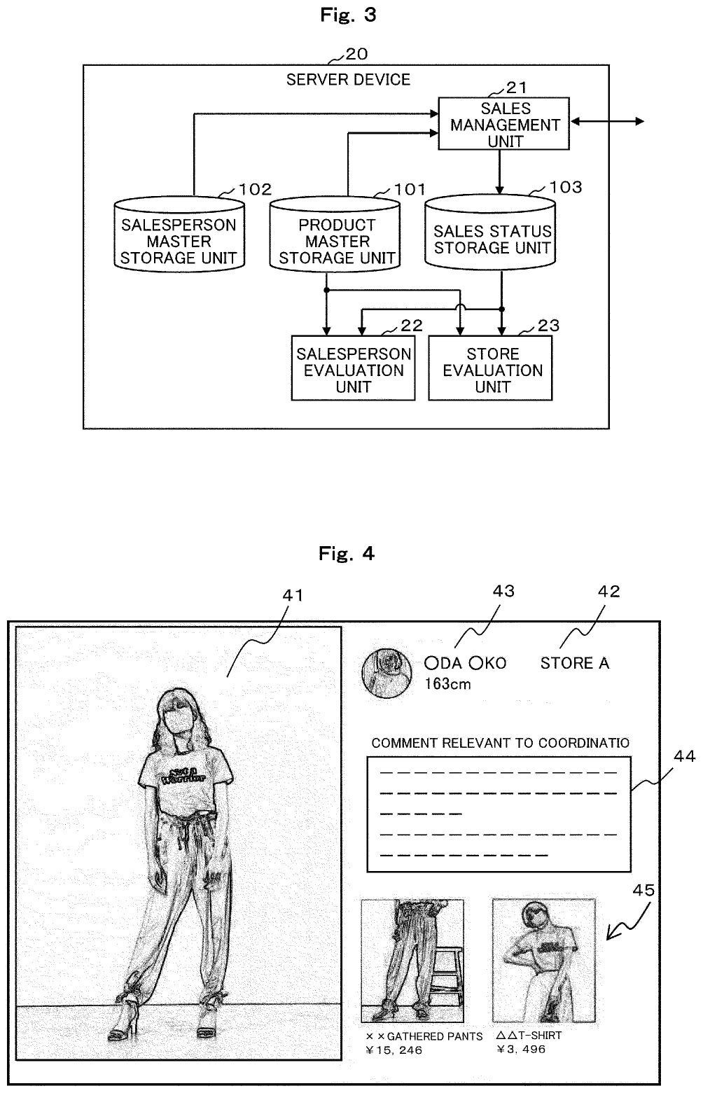

FIG. 3 is a block diagram illustrating a functional configuration example of the server device 20 according to this embodiment. As illustrated in FIG. 3, the server device 20 of this embodiment includes a sales management unit 21, a salesperson evaluation unit 22, and a store evaluation unit 23, as a functional configuration. In addition, the server device 20 includes a product master storage unit 101, a salesperson master storage unit 102, and a sales status storage unit 103, as a storage medium.

Each of the functional blocks 21 to 23 described above can be configured by any of hardware, a digital signal processor (DSP), and software. For example, in a case where each of the functional blocks is configured by the software, each of the functional blocks 21 to 23 described above actually includes CPU, RAM, ROM, or the like of a computer, and is attained by operating a program (including an evaluation program) stored in a storage medium such as RAM, ROM, a hard disk, or a semiconductor memory.

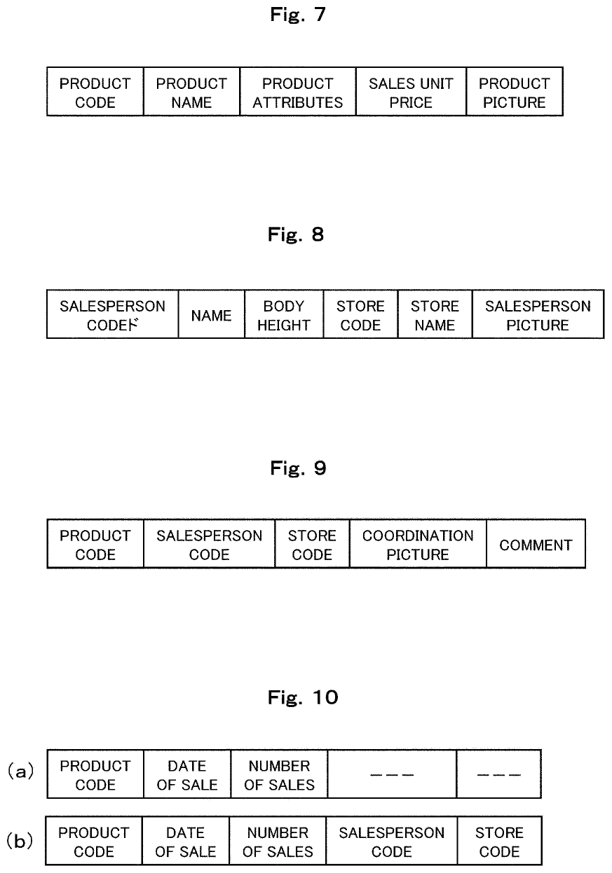

The product master storage unit 101 stores the product master information relevant to a plurality of sales target products. FIG. 7 is a diagram illustrating an example of the product master information stored in the product master storage unit 101. As illustrated in FIG. 7, the product master storage unit 101 stores information such as the product code, the product name, product attributes, a sales unit price, and the product picture (or an address indicating a storage site thereof), for each of the plurality of sales target products. The product attributes are information for specifying the attributes in a case where the same products have different attributes. For example, the product attributes are the color, the size, or the like of the product. Note that, the information described here is an example, and the product master information may include information other than the above information.

The salesperson master storage unit 102 stores the salesperson master information relevant to a plurality of salespersons. FIG. 8 is a diagram illustrating an example of the salesperson master information stored in the salesperson master storage unit 102. As illustrated in FIG. 8, the salesperson master storage unit 102 stores information such as the salesperson code, the name, the body height, the store code, the store name, and the salesperson member (or an address indicating a storage site thereof), for each of the plurality of salespersons. Note that, the information described here is an example, and the salesperson master information may include information other than the above information.

The sales management unit 21 executes various processing pieces that are required when selling the sales target product on the EC site. The sales management unit 21 also has the function of an information management unit of the claims, and thus, also executes processing relevant to the information management unit. For example, the sales management unit 21 executes processing relevant to the generation and the provision of the product catalog page (not illustrated) and processing relevant to the generation and provision of the product detailed page illustrated in FIG. 5. Here, the sales management unit 21 generates the product catalog page and the product detailed page by using the product master information stored in the product master storage unit 101. The product detailed page is generated in accordance with either the transition from the product catalog page or the transition from the coordination posting page illustrated in FIG. 4.

In addition, the sales management unit 21 also executes various processing pieces relevant to the implementation (the coordination posting) of the sales promotion of the sales target product. That is, the sales management unit 21 extracts the product information of the product desired by the salesperson from the product master information stored in the product master storage unit 101 and provides the extracted product information, in accordance with a request from the product information acquisition unit 11 of the salesperson terminal 10. In addition, the sales management unit 21 receives the posting-related information transmitted by the information posting unit 12 of the salesperson terminal 10, and sequentially records the posting-related information in the sales status storage unit 103 (the function of the information management unit).

FIG. 9 is a diagram illustrating an example of the posting-related information stored in the sales status storage unit 103. FIG. 9 illustrates one record that stores the posting-related information, and records are added one by one each time when the sales management unit 21 receives the coordination information from the salesperson terminal 10.

As illustrated in FIG. 9, the sales status storage unit 103 stores the posting-related information in which the product code, the salesperson code, the store code, the coordination picture, and the comment are associated with each other, in one record. Regarding to the product code, a plurality of product codes are included corresponding to a plurality of products included in the coordination picture. The coordination picture and the comment may be stored in a site different from the record, and an address indicating the storage site may be stored in the record.

The posting-related information illustrated in FIG. 9 is used as sales promotion management information for managing the product information indicating the product, the salesperson information indicating the salesperson, and the store information indicating the store to which the salesperson belongs in association with each other, for the product subjected to the sales promotion by the salesperson. Note that, the sales promotion management information may be stored separately from the posting-related information. In this case, a posting code for uniquely specifying each of the posting-related information pieces is issued, and the sales promotion management information may be configured by associating the posting code with the product code, the salesperson code, and the store code.

In addition, the sales management unit 21 also executes processing relevant to the generation and the provision of the posting list page illustrated in FIG. 6. Here, the sales management unit 21 generates the posting list page by using the coordination picture, the salesperson code, and the store code in the posting-related information of FIG. 9 that is stored in the sales status storage unit 103, and the salesperson master information stored in the salesperson master storage unit 102.

In addition, the sales management unit 21 also executes processing relevant to the generation and the provision of the coordination posting page illustrated in FIG. 4. Here, the sales management unit 21 generates the coordination posting page by using the posting-related information of FIG. 9 that is stored in the sales status storage unit 103, the product master information stored in the product master storage unit 101, and the salesperson master information stored in the salesperson master storage unit 102.

Further, the sales management unit 21 also executes processing relevant to the registration of the product designated by the consumer to the shopping cart, processing relevant to the payment of the product registered to the shopping cart, or the like. That is, the sales management unit 21 also executes processing relevant to the purchase of the sales target product that is performed through the access to an EC site from a consumer terminal, which is not illustrated. The consumer is capable of performing a set of procedures for browsing the plurality of sales target products on the EC site, and selecting and purchasing a desired sales target product from the plurality of sales target products, and processing relevant to the set of procedures is executed by the sales management unit 21.

The sales management unit 21 records sales status information indicating a status relevant to the sales of the product through the EC site in the sales status storage unit 103 (the function of the information management unit). For example, in a case where the consumer purchases the sales target product through the EC site, the sales management unit 21 records information indicating when and how many sales target products are sold, that is, information indicating the sales performance of the product in the sales status storage unit 103, as the sales status information.

Here, in a case where the product is registered to the shopping cart in accordance with the transition to the product detailed page illustrated in FIG. 5 from the coordination posting page illustrated in FIG. 4, the salesperson code and the store code of the salesperson, which are used when generating the coordination posting page, are associated with the product code of the product. In this case, the sales management unit 21 records the sales status information including the product code, the date of sale, and the number of sales of the sold product in the sales status storage unit 103, in association with the salesperson code and the store code of the salesperson who has posted the coordination. That is, the sales management unit 21 records the sales status information relevant to the product subjected to the sales promotion by the salesperson (sales performance information) among the target products sold on the EC site in the sales status storage unit 103, in association with the salesperson code and the store code included in the posting-related information (the sales promotion management information) of FIG. 9.

On the other hand, in a case where the product is registered to the shopping cart in accordance with the transition to the product detailed page illustrated in FIG. 5 from the product catalog page which is not illustrated, the salesperson code and the store code are not associated with the product code of the product. In this case, the sales management unit 21 records the product code, the date of sale, and the number of sales of the sold product in the sales status storage unit 103, as the sales status information, but does not perform the association with the salesperson code and the store code.

FIG. 10 is a diagram illustrating an example of the sales status information (the sales performance information) stored in the sales status storage unit 103. FIG. 10 illustrates one record that stores the sales status information, and records are added one by one each time when the purchase of the sales target product by the consumer is detected by the sales management unit 21.

As illustrated in FIG. 10(a), the sales status storage unit 103 stores the product code of the sold product in accordance with the transition to the product detailed page of FIG. 5 from the product catalog page, the date of sale and the number of sales in one record, as the sales status information. In addition, as illustrated in FIG. 10(b), the sales status storage unit 103 stores the product code of the sold product in accordance with the transition to the product detailed page of FIG. 5 from the coordination posting page, the date of sale and the number of sales in one record, as the sales status information, and stores the salesperson code and the store code in the same record in association with the sales status information. The record illustrated in FIG. 10(b) can be referred to as information in which the sales status information (the product code, the date of sale, and the number of sales) indicating the status (the sales performance) relevant to the sales of the product on the EC site of the company, the salesperson information (the salesperson code) indicating the salesperson who has performed the sales promotion of the product, and the store information (the store code) indicating the store to which the salesperson belongs are associated with each other.

The salesperson evaluation unit 22 evaluates each of the salespersons from the status (the sales performance of the product) relevant to the sales of the product subjected to the sales promotion by each of the salespersons, on the basis of an association between the sales status information indicating the status relevant to the sales of the product on the EC site of the company and the salesperson information indicating the salesperson who has performed the sales promotion of the product. For example, the salesperson evaluation unit 22 obtains an evaluation value relevant to the sales performance of the salesperson per unit period, on the basis of the sales status information (the product code, the date of sale, and the number of sales) and the salesperson information (the salesperson code), which are illustrated in FIG. 10(b). The unit period is an evaluation target period (for example, one month) at a predetermined time interval during which the salesperson evaluation unit 22 executes the processing.

For example, at the beginning of every month, the salesperson evaluation unit 22 calculates the total sales of the product sold on the basis of the coordination posting of the salesperson per the last one month, for each of the salespersons, and calculates a value obtained by multiplying the total sales amount by a predetermined ratio, as the evaluation value of the salesperson. The total sales of the product sold on the basis of the coordination posting of a certain salesperson A1 can be calculated as follows. That is, among the records of the sales status information for the last month, which are stored in the sales status storage unit 103, one or more records in which the salesperson code of the salesperson A1 is recorded are extracted. Then, the sales unit price corresponding to the product code included in each of the extracted records is checked with the product master information, and the sales unit price is multiplied by the number of sales, and thus, the sales are obtained for each of the records. Then, by summing up the sales obtained for each of the records, the total sales of the salesperson A1 per one month is calculated.

Here, the salesperson evaluation unit 22 may apply an incentive set by a predetermined rule to the salesperson who has performed the sales promotion of the product, on the basis of the sales performance specified for each of the salespersons who has performed the sales promotion of the product. For example, the salesperson evaluation unit 22 may perform processing of setting an amount corresponding to the evaluation value of the salesperson that is calculated as described above (the value obtained by multiplying the total sales per one month by the predetermined ratio (for example, 3%)) to be supplied as a compensation or a bonus.

Alternatively, the salesperson evaluation unit 22 may perform processing of applying a point set by a predetermined rule, on the basis of the evaluation value calculated as described above. The contents of the rule can be set in any manner. Here, the point to be applied, for example, can be an appraisal point for personnel evaluation. Alternatively, the point can also be a point having an economic value that can be used in the actual commercial transaction.

In addition, the salesperson evaluation unit 22 may perform processing of applying the point calculated on the basis of the predetermined rule, on the basis of the number of sales of the sales target product. Here, as the point to be applied per one sale of the sales target product, a point with the same fixed value may be applied to all the sales target products, or different points may be applied to different sales target products.

The store evaluation unit 23 evaluates the store from the overall status relevant to the sales of the product subjected to the sales promotion by each of the salespersons belonging to the store (the total sales performance of each of the salespersons), on the basis of an association between the sales status information indicating the status relevant to the sales of the product on the EC site of the company, the salesperson information indicating the salesperson who has performed the sales promotion of the product, and the store information indicating the store to which the salesperson belongs.

For example, the salesperson evaluation unit 22 obtains an evaluation value relevant to the store per unit period (for example, one month), on the basis of the sales status information (the product code, the date of sale, and the number of sales), the salesperson information (the salesperson code), and the store information (the store code), which are illustrated in FIG. 10(b).

For example, at the beginning of every month, the store evaluation unit 23 calculates the total sales of the product sold on the basis of the coordination posting of each of the salespersons belonging to the store per the last one month, for each of the stores, and calculates a value obtained by multiplying the total sales amount by a predetermined ratio, as the evaluation value of the store. The total sales of the product sold on the basis of the coordination posting of the salespersons A1, A2, . . . belonging to a certain store A can be calculated as follows. That is, for each of the salespersons A1, A2, . . . , the total sales per one month is calculated as described above. Then, by further summing up the total sales of each of the salespersons A1, A2, . . . , the total sales per one month based on the coordination posting of each of the salespersons A1, A2, . . . is calculated for the store A.

Here, the store evaluation unit 23 may apply the incentive set by the predetermined rule to a budget set for the sales of the product at the physical store, on the basis of the total sales performance that is specified for each of the salespersons belonging to the store. For example, the store evaluation unit 23 may add an amount corresponding to the evaluation value of the store that is calculated as described above (the value obtained by multiplying the total sales for one month by the predetermined ratio (for example, 20%)) to the sales at the physical store for the current month, as the incentive, such that the achievement rate of the added amount to the budget is used as the evaluation value of the store.

In this case, for example, when the budget for the current month is 10,000,000 yen, the sales at the physical store is 9,000,000 yen, and the total sales based on the coordination posting of each of the salespersons on the EC site is 6,000,000 yen, 6,000,000 yen x 20%=1,200,000 yen is added to the sales of 9,000,000 yen at the physical store, as the incentive, and thus, a budget achievement rate of 102% is used as the evaluation value of the store. 1,200,000 yen is not the sales of the product sold at the physical store of the store A, but is regarded as a result obtained by the store A approving or recommending the digital customer service of the salespersons A1 and A2, and thus, is reflected on the evaluation of the store A.

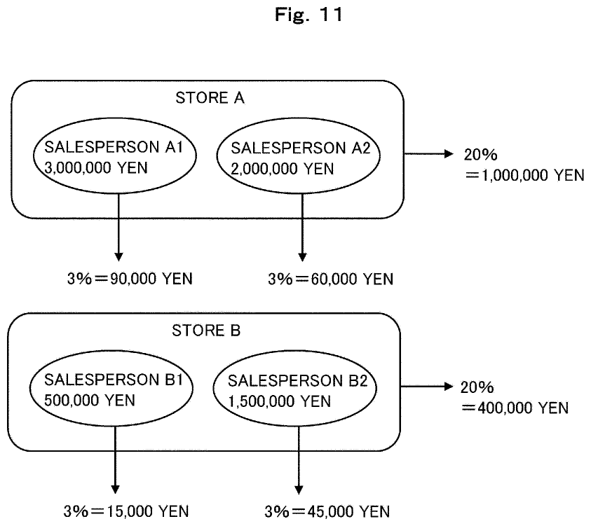

FIG. 11 is a schematic view for illustrating an example of the processing details of the salesperson evaluation unit 22 and the store evaluation unit 23. Here, the company operates two stores of the store A and the store B, two persons of the salespersons A1 and A2 belong to the store A, and two persons of the salespersons B1 and B2 belong to the store B. The total sales per unit period relevant to one or more sales target products sold through the coordination posting page of the salesperson A1 of the store A is 3,000,000 yen, similarly the total sales of the salesperson A2 of the store A is 2,000,000 yen, similarly the total sales of the salesperson B1 of the store B is 500,000 yen, and similarly the total sales of the salesperson B2 of the store B is 1,500,000 yen.

In this case, the salesperson evaluation unit 22, for example, applies an amount obtained by multiplying each of the total performances by the predetermined ratio (for example, 3%) (90,000 yen, 60,000 yen, 15,000 yen, and 45,000 yen, respectively) or a point corresponding thereto to each of the salespersons A1, A2, B1, and B2, as the incentive. In addition, for the store A, the store evaluation unit 23 adds 1,000,000 yen that is an amount obtained by multiplying 5,000,000 yen, which is the total sales based on the coordination posting by each of the salespersons A1 and A2, by the predetermined ratio (for example, 20%) to the sales at the physical store for the current month, as the incentive. Similarly, for the store B, the store evaluation unit 23 adds 40,0000 yen that is an amount obtained by multiplying 2,000,000 yen, which is the total sales based on the coordination posting by each of the salespersons B1 and B2, by the predetermined ratio (for example, 20%) to the sales at the physical store for the current month, as the incentive.

As described above in detail, in this embodiment, each of the salespersons is evaluated from the status relevant to the sales of the product subjected to the sales promotion by each of the salespersons (the product sold through the coordination posting page of the salesperson), on the basis of the association between the sales status information indicating the status relevant to the sales of the product on the EC site of the company and the salesperson information indicating the salesperson who has performed the sales promotion of the product, and the store is evaluated from the overall status relevant to the sales of the product (the same as above) subjected to the sales promotion by each of the salespersons belonging to the store, on the basis of the association between the sales status information, the salesperson information, and the store information indicating the store to which the salesperson belongs.

According to this embodiment configured as described above, in a case where the salesperson of the company operating one or more physical stores and EC sites performs the sales promotion (the digital customer service using the coordination posting) in order to sell the product on the EC site, not only the salesperson oneself is evaluated on the basis of the status relevant to the sales of the product, but also the store to which the salesperson belongs is evaluated on the basis of the overall status relevant to the sales of the product subjected to the sales promotion by each of the salespersons belonging to the store.

As described above, according to this embodiment, in a case where the salesperson sells more products on the EC site through the digital customer service, not only the salesperson but also the store is evaluated, and thus, a store manager can be inhibited from suppressing the implementation of the digital customer service by the salesperson, that is, the negative factor that cause the demotivation for the salesperson to the sales of the product on the EC site can be inhibited. Accordingly, it is possible to improve the sales performance of the product by effectively using the motivation of the salesperson to sell more products.

Note that, in the embodiment described above, an example has been described in which the sales performance information indicating the sales performance of the product is used as the sales status information, and the salesperson and the store are evaluated on the basis of the sales performance information, but the invention is not limited thereto. For example, the evaluation may be performed by using at least one of the sales performance information, information indicating the implementation status of the sales promotion performed by the salesperson (sales promotion status information), and information indicating the reaction status of the consumer with respect to the sales promotion (sales promotion reaction information). For example, the salesperson evaluation unit 22 may evaluate each of the salespersons from at least one of the sales performance of the product subjected to the sales promotion by each of the salespersons, the implementation status of the sales promotion, and the reaction status of the consumer, and the store evaluation unit 23 may evaluate the store from the total sales performance of the product subjected to the sales promotion by each of the salespersons belonging to the store.

Here, the salesperson evaluation unit 22 and the store evaluation unit 23, for example, are capable of calculating the evaluation value by using the sales performance information in (A) described below, the sales promotion status information in (B) described below, and the sales promotion reaction information in (C) described below.

(A) Performance of Salesperson: the total sales of sales promotion target product sold by the salesperson through the coordination post during a unit period

(B) Number of Contents Postings: the total number of coordination information pieces posted by the coordination posting

(C) Number of PVs: the total number of PVs of the coordination posting page

In addition, in the embodiment described above, an example has been described in which the sales promotion performed by the salesperson is the coordination posting on the EC site of the company, but the invention is not limited thereto. For example, the sales promotion may be processing of posting a comment relevant to the point or the feature of the sales target product that is seen from the salesperson and is easily grasped on the EC site, processing of posting the sales target product (including the coordination), the comment relevant thereto, and the like on the personal SNS (such as Instagram, Facebook, and LINE, which are the registered trademark) of the salesperson, or the like.

In addition, in the embodiment described above, an example has been described in which the sales promotion by the salesperson is performed on the EC site of the company, but the invention is not limited thereto. For example, a target website on which the sales promotion is performed may be a website for sales promotion that is created by the salesperson oneself.

In addition, in the embodiment described above, various information pieces are illustrated in FIGS. 7 to 10, but such drawings illustrate an example of a method for storing various information pieces in the sales status storage unit 103, and the invention is not limited thereto. In conclusion, various information pieces may be stored in a form in which the association between the sales status information, the salesperson information, and the store information can be grasped.

In addition, in the embodiment described above, a case in which the sales target product is the fashion-related product has been described as an example, but the sales target product is not limited thereto. Any product can be the target. In addition, the product to be used may be either a product as an object or a product as a service.

In addition, the embodiment described above is merely an example of specification for implementing the invention, and the technical scope of the invention should not be construed to be restrictive thereby. That is, the invention can be implemented in various forms without departing from the gist or the main features thereof.

### REFERENCE SIGNS LIST

10: salesperson terminal
11: product information acquisition unit
12: information posting unit
20: server device (evaluation device)
21: sales management unit (information management unit)
22: salesperson evaluation unit
23: store evaluation unit
101: product master storage unit
102: salesperson master storage unit
103: sales status storage unit

1. An evaluation device; applied to a sales environment in which sales target products of a company operating one or more physical stores and EC sites are sold on the EC site through a product catalog page displaying the sales target products as a list, and among the sales target products of the company, a product selected by a salesperson as a target of a sales promotion that is performed by the salesperson in order to sell the product on the EC site without any relation to a customer service at the physical store is sold on the EC site through a sales promotion web page by the salesperson, which is different from the product catalog page, the device characterized by comprising:
an information management unit recording sales status information indicating a status in which the product is sold, salesperson information indicating the salesperson who has performed the sales promotion of the selected product, and store information indicating a store to which the salesperson belongs in association with each other when the product is sold on the EC site as a result of the sales promotion performed by the salesperson through the sales promotion web page, and recording the sales status information indicating the status in which the product is sold without associating the sales status information with the salesperson information and the store information when the product is sold on the EC site through the product catalog page;
a salesperson evaluation unit evaluating each of the salespersons from a status relevant to sales of the product subjected to the sales promotion by each of the salespersons, on the basis of the sales status information and the salesperson information, which are recorded in association with each other by the information management unit, in accordance with the sales of the product on the EC site as the result of the sales promotion performed by the salesperson through the sales promotion web page; and
a store evaluation unit evaluating a store from an overall status in which the product that is selected by each of the salespersons belonging to the store and is subjected to the sales promotion is sold on the EC site through the sales promotion web page, on the basis of the sales status information, the salesperson information and the store information, which are recorded in association with each other by the information management unit, in accordance with the sales of the product on the EC site as the result of the sales promotion performed by the salesperson through the sales promotion web page.

2. The evaluation device according to claim 1,
wherein the information management unit
manages product information indicating the product, the salesperson information indicating the salesperson, and the store information indicating the store to which the salesperson belongs in association with each other, as sales promotion management information, for the product subjected to the sales promotion by the salesperson, and
manages the sales status information relevant to the product subjected to the sales promotion by the salesperson, among the sales target products sold on the EC site, in association with the salesperson information and the store information included in the sales promotion management information.

3. The evaluation device according to claim 1, characterized in that
the sales status information includes information indicating a sales performance of the product subjected to the sales promotion by each of the salespersons,
the salesperson evaluation unit evaluates each of the salespersons from the sales performance of the product sold through the sales promotion by each of the salespersons, and
the store evaluation unit evaluates the store from a total sales performance of the product subjected to the sales promotion by each of the salesperson belonging to the store.

4. The evaluation device according to claim 3, characterized in that
the salesperson evaluation unit applies an incentive set by a predetermined rule to the salesperson who has performed the sales promotion, on the basis of the sales performance specified for each of the salespersons who has performed the sales promotion.

5. The evaluation device according to claim 3, characterized in that
the store evaluation unit applies the incentive set by the predetermined rule to a budget set for the sales of the product in the physical store, on the basis of the total sales performance specified for each of the salespersons belonging to the store.

6. The evaluation device according to claim 1, characterized in that
the sales status information includes at least one of information indicating an implementation status of the sales promotion performed by the salesperson and information indicating a reaction status of a consumer with respect to the sales promotion, in addition to the information indicating the sales performance of the product subjected to the sales promotion by each of the salespersons,
the salesperson evaluation unit evaluates each of the salespersons from at least one of the sales performance of the product subjected to the sales promotion by each of the salespersons, the implementation status of the sales promotion, and the reaction status of the consumer, and
the store evaluation unit evaluates the store from the total sales performance of the product subjected to the sales promotion by each of the salespersons belonging to the store.

7. An evaluation system applied to a sales environment in which sales target products of a company operating one or more physical stores and EC sites are sold on the EC site through a product catalog page displaying the sales target products as a list, and among the sales target products of the company, a product selected by a salesperson as a target of a sales promotion that is performed by the salesperson in order to sell the product on the EC site without any relation to a customer service at the physical store is sold on the EC site through a sales promotion web page by the salesperson, which is different from the product catalog page, characterized by comprising:
a salesperson terminal used by a salesperson; and
a server device connected from the salesperson terminal through a communication network,
wherein the server device includes:
an information management unit recording sales status information indicating a status in which the product is sold, salesperson information indicating the salesperson who has performed the sales promotion of the selected product, and store information indicating a store to which the salesperson belongs in association with each other when the product is sold on the EC site as a result of the sales promotion performed by the salesperson through the sales promotion web page, and recording the sales status information indicating the status in which the product is sold without associating the sales status information with the salesperson information and the store information when the product is sold on the EC site through the product catalog page;
a salesperson evaluation unit evaluating each of the salespersons from a status relevant to sales of the product subjected to the sales promotion by each of the salespersons, on the basis of the sales status information and the salesperson information, which are recorded in association with each other by the information management unit, in accordance with the sales of the product on the EC site as the result of the sales promotion performed by the salesperson through the sales promotion web page; and
a store evaluation unit evaluating a store from an overall status in which the product that is selected by each of the salespersons belonging to the store and is subjected to the sales promotion is sold on the EC site through the sales promotion web page, on the basis of the sales status information, the salesperson information and the store information, which are recorded in association with each other by the information management unit, in accordance with the sales of the product on the EC site as the result of the sales promotion performed by the salesperson through the sales promotion web page,
the salesperson terminal includes
an information posting unit posting information relevant to the sales promotion on sales promotion web page, and
the information posting unit performs the posting on the sales promotion web page by associating product information indicating a product to be subjected to the sales promotion, the salesperson information indicating the salesperson performing the sales promotion, and the store information indicating the store to which the salesperson performing the sales promotion belongs with the information relevant to the sales promotion.

8. The evaluation system according to claim 7, characterized in that
the information management unit
manages the product information indicating the product, the salesperson information indicating the salesperson, and the store information indicating the store to which the salesperson belongs in association with each other, as sales promotion management information, for a product subjected to the posting on the sales promotion web page by the salesperson, and
manages the sales status information relevant to the product subjected to the sales promotion by the salesperson, among the sales target products sold on the EC site, in association with the salesperson information and the store information included in the sales promotion management information.

9. An evaluation program stored on a non-transitory computer readable medium for allowing a computer of an evaluation device applied to a sales environment in which sales target products of a company operating one or more physical stores and EC sites are sold on the EC site through a product catalog page displaying the sales target products as a list, and among the sales target products of the company, a product selected by a salesperson as a target of a sales promotion that is performed by the salesperson in order to sell the product on the EC site without any relation to a customer service at the physical store is sold on the EC site through a sales promotion web page by the salesperson, which is different from the product catalog page, to function as:
information management means recording sales status information indicating a status in which the product is sold, salesperson information indicating the salesperson who has performed the sales promotion of the selected product, and store information indicating a store to which the salesperson belongs in association with each other when the product is sold on the EC site as a result of the sales promotion performed by the salesperson through the sales promotion web page, and recording the sales status information indicating the status in which the product is sold without associating the sales status information with the salesperson information and the store information when the product is sold on the EC site through the product catalog page;
salesperson evaluation means evaluating each of the salespersons from a status relevant to sales of the product subjected to the sales promotion by each of the salespersons, on the basis of the sales status information the salesperson information, which are recorded in association with each other by the information management means, in accordance with the sales of the product on the EC site as the result of the sales promotion performed by the salesperson through the sales promotion web page; and
store evaluation means evaluating a store from an overall status in which the product that is selected by each of the salespersons belonging to the store and is subjected to the sales promotion is sold on the EC site through the sales promotion web page, on the basis of the sales status information, the salesperson information and the store information, which are recorded in association with each other by the information management means, in accordance with the sales of the product on the EC site as the result of the sales promotion performed by the salesperson through the sales promotion web page.
